(19) United States
(12) Patent Application Publication
(10) Pub. No.: US 2013/0129415 A1
(43) Pub. Date: May 23, 2013

(54) FITTING DEVICE

(71) Applicant: Siegfried Schröcker, Rosenau am Hengstpass (AT)

(72) Inventor: Siegfried Schröcker, Rosenau am Hengstpass (AT)

(21) Appl. No.: 13/813,785

(22) PCT Filed: Aug. 3, 2011
(86) PCT No.: PCT/AT11/00333

§ 371 Date: Feb. 1, 2013

(30) Foreign Application Priority Data
Aug. 4, 2010 (AT) A 1302/2010

(51) Int. Cl. F16B 17/00

(52) U.S. Cl. CPC F16B 17/00
USPC 403/373

(57) ABSTRACT

A fitting device is fittable in an opening, which fitting device includes at least one corner element, one side element, at least one adjusting device, and one fastening device connected to the side element via the adjusting device for positioning the side element against a side edge of the opening. The at least one corner element is provided as a rigid element in the extension plane of the fitting device, and the fastening device is connected to the corner element via the adjusting device for positioning the corner element against a side edge of the opening. The adjusting elements connected to the corner element or the side element are arranged radially around the one fastening device.

### CROSS-REFERENCE TO RELATED APPLICATIONS

This application is a Section 371 of International Application No. PCT/AT2011/000333, filed Aug. 3, 2011, which was published in the German language on Feb. 9, 2012, under International Publication No. WO 2012/016265 A3 and the disclosure of which is incorporated herein by reference.

### BACKGROUND OF THE INVENTION

The present invention relates to a fitting device fittable in an opening, which fitting device comprises at least one corner element, one side element, adjusting devices, and one fastening device connected to the side element via one of the adjusting devices for positioning the side element against a side edge of the opening.

German utility model DE 10 2006 026 366 A1 describes a fitting device for openings in a wall. The fitting device disclosed consists of an element for keeping out water that is kept in the opening by a frame. The frame can be altered in its height and width and is braced against a wall rebate formed by the opening by lengthwise and crosswise bracing.

The fitting device described in DE 10 2006 026 366 A1 has the disadvantage that fitting it into the opening of the wall is rather laborious, because a plurality of lengthwise and crosswise bracings have to be operated individually. An alteration of the width of the frame by a crosswise bracing is hard to achieve, because the lengthwise bracing causes friction between the frame and the wall rebate.

British published patent application GB 2 373 534 A discloses a fitting device comprising horizontal and vertical elements that are pressed against the jambs of an opening. The fitting device described in GB 2 373 534 A differs from the fitting device explained below in that it does not have any rigid corner elements that are inserted into the corners of the jambs of the opening.

### BRIEF SUMMARY OF THE INVENTION

The object of the invention discussed herein is to provide a fitting device fittable into an opening and braceable therein by an easily implementable method. The inventive fitting device is characterized by a systematic arrangement of the adjusting device and fastening device, wherein the systematic arrangement described below allows bracing the fitting device in openings with any, in particular rectangular and round, cross-sections.

One area of application of the inventive fitting device is flood defense. For this purpose, the fitting device is positioned in a wall opening as an opening optionally parallel to a door or a window in order to close this wall opening in a waterproof fashion.

In addition, the fitting device may be fitted in an opening to form a static system with the elements forming the boundaries of the opening. One example of such an application is securing a wall opening against collapsing. Furthermore, the inventive fitting device may be fitted in scaffolding comprising supports and beams to stiffen it in the plane of the inventive fitting device.

Also, the inventive fitting device may be used as a casing element fittable in a wall opening or in an opening between supports and beams of a casing support structure.

A first embodiment of the inventive fitting device is fittable in an opening, which fitting device comprises at least one corner element, one side element, at least one adjusting device, and one fastening device connected to the side element via one of the adjusting devices for positioning the side element against a side edge of the opening. The first inventive embodiment of the fitting device is characterized in that the at least one corner element is provided as a rigid element in the plane in which the fitting device extends, the one fastening device is connected to the corner element via the adjusting device for positioning the corner element against a side edge of the opening, wherein the adjusting devices connected to the corner element or the side element are arranged radially around the one fastening device.

By operating the one fastening device, the at least one corner element and the at least one side element may be positioned against the side edge of the opening, so that the fitting device inserted into the opening is fittable in the wall opening by moving the at least one corner element and the at least one side element.

A second embodiment of the inventive fitting device is insertable into an opening. The fitting device comprises at least three side elements, adjusting devices, adjusting devices coupled to the side elements, as well as a fastening device coupled to at least one of the adjusting devices for positioning the side elements against a respective side edge of the opening. The inventive second fitting device is characterized in that the adjusting devices are arranged essentially radially around the one fastening device.

By operating the one fastening device, the at least three side elements may be positioned against the side edge of the opening, so that the fitting device inserted into the opening is fittable in the opening by an enlargement of the surface extension of the fitting device enforced by the movement of the at least three corner elements.

A third embodiment of the inventive fitting device is fittable in an opening and comprises at least three corner elements, adjusting devices, and a fastening device connected to the corner elements via adjusting devices. The inventive third embodiment is characterized in that the at least three corner elements are provided as rigid elements, the one fastening device is connected to at least one corner element via one of the adjusting devices, wherein the adjusting devices are arranged essentially radially around the one fastening device.

By operating the one fastening device, the at least three corner elements may be positioned against the side edge of the opening so that the fitting device inserted into the opening is fittable in the opening by an enlargement of the extension surface of the fitting device enforced by the movement of the corner elements.

Preferably, the corner elements and optionally the side elements or the adjusting elements are supported in a linearly displaceable fashion. The orientation of the linearly displaceable support is oriented essentially parallel to the arrangement of an adjusting element.

By pressing at least one corner element against the side edges of the opening and simultaneously pressing a further corner element or a side element against the side edge of the opening, the fitting device is strutted apart.

The details given here for the arrangement of the adjusting elements refer to an arrangement of the adjusting device regarding its axes of action.

If the fitting device comprises two adjusting devices, a radial arrangement of the two adjusting devices is provided in a way that the adjusting elements extend along one axis.

The adjusting element is or the adjusting elements are positioned at the center point of the radially arranged adjusting devices, wherein the forces required for adjusting the adjusting devices are in equilibrium at the center point.

A side edge and a further side edge of the opening may form a corner of the opening against which a corner element is placeable. The one side edge must not necessarily be at a right angle to the further side edge, but it can be arranged at any angle. A side edge and a further side edge may form a positive or a negative angle, against which angle the corner element is placeable. Also, a side edge and a further side edge may have a polygonal transition.

A corner element differs from a side element in that the corner element is placed against two side edges of the opening. Moving the corner element in the course of placing the corner element against the side edge in a direction essentially parallel to one of the side edges of the opening is not possible.

A corner element can consist of two leg elements forming an angle therebetween and being connected to each other in a rigid fashion.

In a preferred arrangement the adjusting devices are arranged along an axis running through the central point. In such an arrangement, the pressure forces applied via the fastening device to the adjusting device and subsequently via the corner or side element to a side edge of the opening are inversely equal.

If the extension surface of the fitting device is divided into only one subarea, the fitting device preferably has only one fastening device. If the extension surface of the fitting device is divided into two or more subareas, the fitting device preferably has two or more fastening devices.

A subarea of the extension surface may be arranged overlapping another subarea of the extension surface.

The fastening device causes pressure and/or movement of the adjusting device toward a side edge of the opening. By the pressure force applied by the fastening device via the adjusting device, the corner element and the side element, the fitting device is fittable in the opening.

The fitting device may comprise mechanical and/or hydraulic components creating such a pressure force. The fitting device may further comprise a locking device, which reduces the pressure force applied and subsequently prevents release of the fastening device.

One embodiment of the inventive fitting device may be characterized in that the adjusting device comprises first adjusting elements and a second adjusting element, wherein the second adjusting element is coupled to the fastening device and the first adjusting elements, and at least one of the first adjusting elements is coupled to the second adjusting element and the corner element or side element, wherein at least the second adjusting element is arranged on the adjusting axis and the first adjusting elements are arranged at any angle to the adjusting axis.

Two first adjusting elements are connected with the corner element or the side element. This arrangement guarantees better distribution of the pressure forces applied by the adjusting devices to the side edges of the opening. Preferably, the corner elements and/or the side elements are formed in a way that the applied pressure forces can be introduced optimally. For example, the corner element and/or the side element have higher flexural rigidity at their coupling points with the first adjusting element.

Preferably, the first adjusting elements are arranged at a defined angle to the adjusting axis, so that the second adjusting element is not charged with transverse forces. Usually, each of the first adjusting elements is arranged mirror-symmetrically with another one and diverging by the same angle from the adjusting axis.

The corner element may have flexible subsections, so that the shape of the corner element is adaptable to the side edge and/or a side of the fitting device may be stretched.

The corner element may comprise a seal that is arranged in a way that an airtight or watertight closure of the opening in its corner element subsection can be effected.

The seal may comprise seal subsections that may be filled with a fluid. Preferably, the seal subsections are in fluid communication with a hydraulic fastening device so that by operating the fitting device, the fitting device can be fitted in the opening and the seal subsections can be filled.

If the corner element and the side element are connected in an unmovable fashion, stretching the side may also be effected by expanding one leg of the corner element.

The side element may be formed parallel to the longitudinal axis of the corner element and extractably therefrom, so that the respective side of the fitting device at which the side element extends is stretchable.

The seal may be provided as an expandable band enclosing the circumference of the fitting device formed by the corner elements and/or side elements, the expansion force of which counteracts stretching of one side of the fitting device.

Also, the side element may comprise a first side subelement and a second side subelement, wherein the second side subelement is supported parallel to the longitudinal axis of the first side subelement so that an extension of the side of the fitting device is achievable by displacing the second side subelement with regard to the first side subelement.

The individual embodiments described that allow stretching of a side element may be combined within the framework of this invention.

The side element may have flexible subsections, so that the shape of the side element is adaptable to the side edge.

For example, the side element may comprise a seal by which the fitting device may tightly close the opening along the side element. Preferably, an expandable seal is provided around the circumferential edge of the surface extension. The seal in each subsection is expandable to the same extent as the side element is stretched.

Preferably, several adjusting devices are operable by one fastening device.

The fastening device may be formed in such a way that a fastening process, which is initiated by operating the fastening device, comprises several main fastening processes and secondary fastening processes. The main fastening processes serve, for example, for placing the corner elements against the side edges, while the secondary fastening processes place the side elements against the side edges.

The fitting device may comprise a surface element, which surface element extends over at least subsections of the extension surface and is mountable at the corner element and/or the side element and optionally supportable at the adjusting devices.

The fitting device may comprise two surface elements, which are arranged in such a way that at least the adjusting device is arranged essentially between the surface elements.

A surface element may comprise several surface subelements, if they are arranged in an overlapping fashion. The surface subelements are displaceable parallel to their extension plane, so that the surface element can be made larger or smaller by displacing the surface subelement.

The surface element may be expandable.

The surface element may have a curved shape or the shape of a surface with a prism-like or pyramid-like geometry, wherein an enlargement of the extension of the surface element is achievable by changing the curved form or the pyramid-like form.

The adjusting device may, in one possible embodiment of the inventive fitting device, be arranged at an angle to a plane, which plane is defined by the corner elements and/or by the side elements, so that a force acting on an adjusting device, which force is essentially orthogonal to the plane, is dischargeable via a pressure load of the adjusting device onto the side edge of the opening.

The adjusting elements may be adjustable in their length by a setting device, so that the extension surface differs from the opening to the same extent as the extension surface is expandable by the fastening device.

By arranging setting elements for adjusting the length of the adjusting elements, the fitting device may be adaptable better to the shape of the opening.

As mentioned above, the fitting device can be used for closing wall apertures. Such closing may be, for example, a flood defense measure.

The fitting device may be part of a frame that is fittable in the opening. Such a frame can be, for example, a frame of a window or door, which frame is strutted apart within the wall aperture by the inventive fitting device.

A further possibility for using the inventive fitting device is in the field of burglary-resistant closing systems for doors or windows.

For this purpose, the fitting device is supported in a way that it may be pivoted and/or displaced into or from the opening.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown. In the drawings:

FIG. 1 is a plan view showing a first embodiment of the inventive fitting device, which is introduced into an opening having a polygonal cross-section comprising a corner.

FIG. 2 is a plan view showing a further first embodiment of the inventive fitting device, which is introduced into an opening having a polygonal cross-section comprising a corner.

FIG. 3 is a plan view showing a second embodiment of the inventive fitting device, which is introduced into an opening having a circular cross-section.

FIG. 4 is a plan view showing a further first embodiment of the inventive fitting device, which is introduced into an opening having a rectangular cross-section.

FIG. 5 is a cross-sectional representation of the embodiment shown in FIG. 4.

FIG. 6 is a plan view of a third embodiment of the inventive fitting device.

FIG. 7 is a cross-sectional representation of an embodiment of a fastening device for use in an inventive fitting device, operable by compressed air.

FIG. 8 is a cross-sectional representation of a fastening device by which a movement of the adjusting device of an inventive fitting device may be achieved.

FIG. 9 is a cross-sectional representation of a further embodiment of a fastening device of an inventive fitting device.

### DETAILED DESCRIPTION OF THE INVENTION

FIG. 1 shows an application of a first embodiment of the inventive fitting device 1 fittable in an opening 2, such as a window, which fitting device 1 comprises a corner element 3 and two side elements 4, 40 having a curved form corresponding to the circumferential shape of the opening 2, as well as a fastening device 14 coupled to the corner element 3 via the adjusting devices 5, 50 and coupled to the side elements 4, 40, wherein operating the one centrally arranged fastening device 14 leads to a stretching of the at least one side of the fitting device 1 at least in such a way that the side elements 4, 40 are placeable against a side edge 13 of the opening 2 by a movement of the adjusting devices 5, 50 urged by operation of the one fastening device 14. By placing the side edges 4, 40 and the corner element against the side edge 13 of the opening, the fitting device 1 is braced within the opening. The corner element 3 is a rigid element formed in the extension plane of the fitting device with two legs enclosing a right angle. The adjusting device 5, 50 is coupled to the corner element 3 so that the corner element 3 is supportable on two side edges 13 of the opening 2 by a movement of the adjusting devices 5, 50 urged by the operating the one fastening device 14. The adjusting devices 5, 50 are arranged radially around the one fastening device 14, and at least two adjusting devices 5, 50 arranged opposite of each other on an adjusting axis 8 are operable by a fastening device 14. The fitting device 1 introduced into the opening 2 is braceable in the opening 2 by a movement of the corner element and the side element urged by the fastening device 14.

The corner element 3 may be placed against two subsections of the side edge 13 of the opening oriented orthogonally to each other by the adjusting device 5, wherein the adjusting device 5 is coupled to the corner element 3 at a corner contact point 11 and the fastening device 14. Analogously, the side elements 4, 40 may be placed against the side edge 13 of the opening 2 by the adjusting devices 5, 50, wherein the adjusting devices 5, 50 are coupled to the side elements 4, 40 at the lateral contact points 12, 120 and the fastening device 14. The adjusting device 6 comprises first adjusting elements 6, 6′ and a second adjusting element 7, wherein the second adjusting element 7 is coupled to the fastening device 14 and the first adjusting elements 6, 6′, and each one of the first adjusting elements 6, 6′ is coupled to the second adjusting element 7, the corner element 3 or the side element 4, 40. The second adjusting element 7 is arranged on the adjusting axis 8. The first adjusting elements 6, 6′ are arranged at any angle to the adjusting axis 8. The knot between the first adjusting elements 6, 6′ and the second adjusting element 7 is formed as a rigid knot.

The corner element 3 is implemented as a rigid element. Furthermore, the corner element 3 is implemented expandably in subsections adjacent to the side elements 4, 40, so that one side of the fitting device 1 may be stretched while maintaining the connection between the side element and the corner element.

The side elements 4, 40 comprise a first side subelement and a second side subelement, wherein the second side subelement is arranged to be displaceable parallel to the longitudinal extension of the first side subelement, so that an expansion of the side of the fitting device 1 is achievable by displacing the second side subelement with regard to the first side subelement.

The adjusting devices 5, 50 are operable by the fastening device 14.

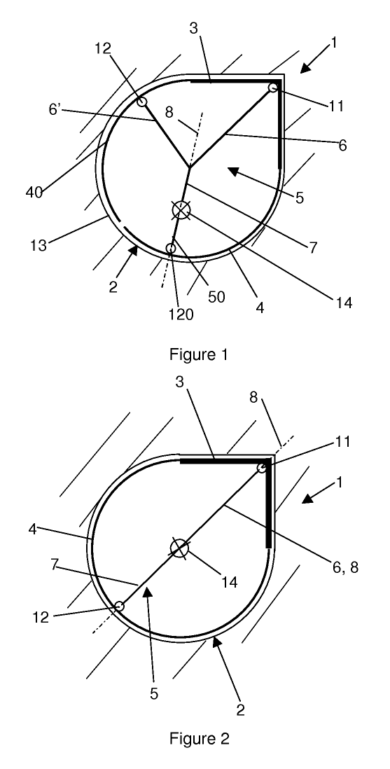

FIG. 2 shows a view of a further first embodiment of the inventive fitting device, which is introduced into an opening 2 having a polygonal cross-section comprising a corner. The embodiment shown in FIG. 2 differs from the embodiment shown in FIG. 1 in that the adjusting device 5 is exclusively coupled to the corner element 3 at the corner contact point 11 and to the one fastening device 14, while the adjusting device 50 is coupled to the side element 4 at the lateral contact point 12 and the one fastening device 14. The adjusting device 5 comprises only a first adjusting element 6 and a second adjusting element 7. The side element 4 is supported parallel to the longitudinal extension of the side element 4 and extractable from the corner element 3, so that the respective side of the fitting device 1 at which the side element 4 extends is stretchable.

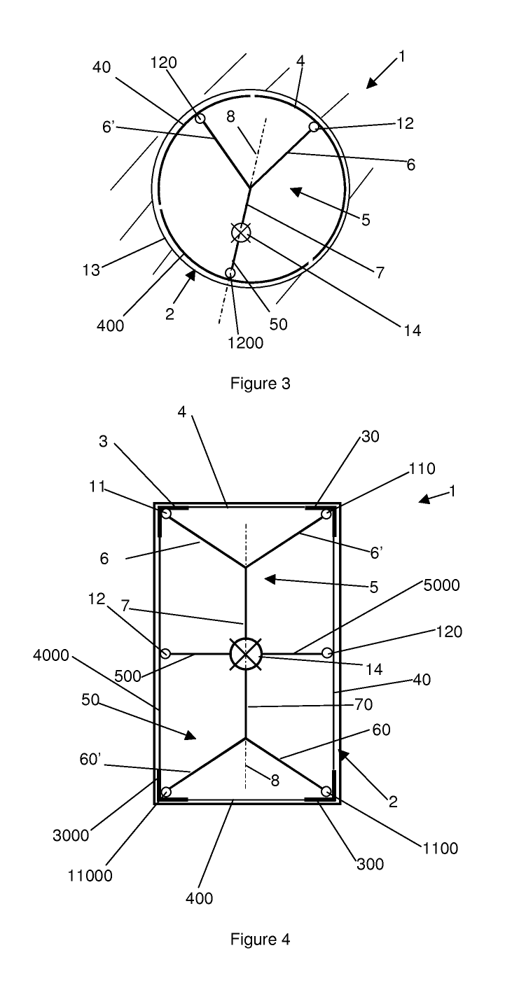

FIG. 3 shows a view of a second embodiment of the inventive fitting device fittable in an opening 2, which fitting device 1 comprises three side elements 4, 40, 400, adjusting devices 5, 50 coupled to the side elements 4, 40, 400, as well as one fastening device 14 coupled to the adjusting devices 5, 50, wherein operating the one fastening device 14 achieves stretching of at least one side of the fitting device 1, in such a way that the side elements 4, 40, 400 are placeable against a side edge 13 of the opening 2 by a movement of the adjusting devices 5, 50 urged by operation the one fastening device 14, wherein the adjusting devices 5, 50 are arranged radially around the one fastening device 14 and at least two adjusting devices 5, 50 arranged opposite to each other on the adjusting axis are operable by the one fastening device 14.

FIG. 4 shows a view of an embodiment of the inventive fitting device introduced into an opening 2 having a rectangular cross-section. The embodiment shown in FIG. 4 comprises four corner elements 3, 30, 300, 3000 and four side elements 4, 40, 400, 4000. Each adjusting device 5, 50 places two of the four corner elements 4, 40, 400, 4000, respectively, against the corners of the opening 2.

The adjusting devices 5, 50 used herefor each comprise two first adjusting elements 6, 6′, 60, 60′, respectively, and a second adjusting element 7, 70, respectively. The first adjusting elements 6, 6′, 60, 60′ are coupled at the corner contact points 11, 110, 1100, 11000 to the corner elements 3, 30, 300, 3000 and to the second adjusting elements 7, 70. The second adjusting elements 7, 70 are coupled to the first adjusting elements 6, 6′, 60, 60′ and the one fastening device 14.

The lateral side elements 40, 4000 are placed against the side edge 13 of the opening 2 by adjusting devices 500, 5000. The adjusting devices 500, 5000 are coupled at the lateral contact points 12, 120 to the side element 40, 4000 and to the one fastening device 14.

By the fastening device 14, the adjusting devices 5, 50, 500, 5000 are operated. The adjusting devices 5, 50, 500, 5000 are arranged radially around the one fastening device.

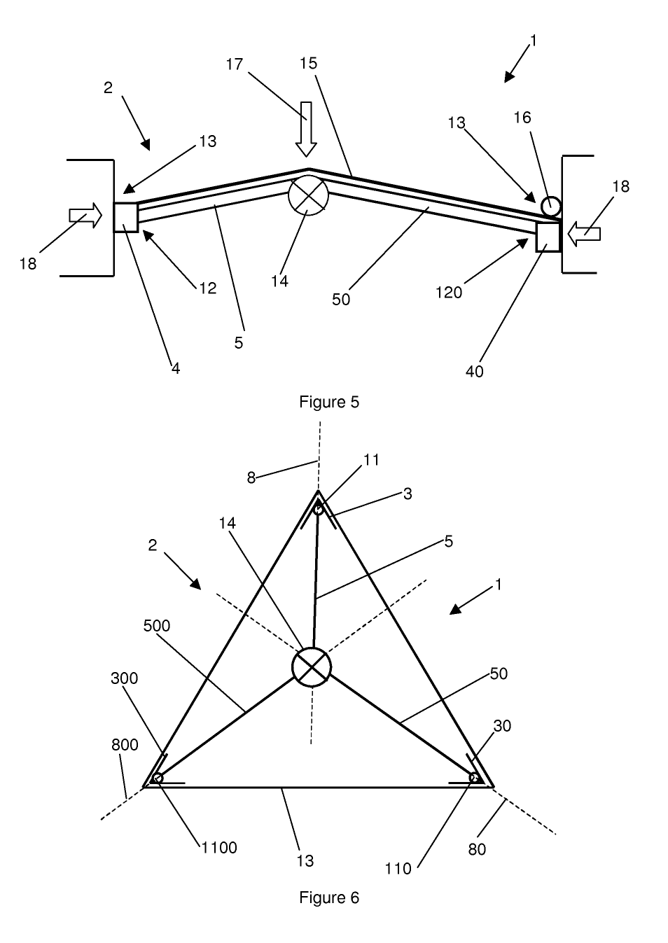

FIG. 5 shows a cross-sectional representation of the embodiment of FIG. 4. It shows a surface element 15 extending essentially over the extension surface. The longitudinal axes of the adjusting devices 5, 50 form an angle different from 180°. The surface element 15 has subsections running adjacently to the respective adjusting devices 5, 50 parallel to the respective adjusting device 5, 50. A vertical force 17, which acts on the adjusting devices 5, 50 in the region of the fastening device 14, is absorbed in the side edge 13 of the opening 2 by horizontal supporting forces 18.

In addition, the fitting device 1 comprises a hinge 16 by which the fitting device 1 may be pivoted into the opening 2 and fixed in the opening 2 in its position within the opening 2 by operating the fastening device 14.

FIG. 6 shows a view of a third embodiment of the inventive fitting device fittable in an opening 2, which fitting device 1 comprises three corner elements 3, 30, 300, adjusting devices 5, 50, 500, as well as one fastening device 14 coupled to the adjusting devices 5, 50, 500, wherein operating the one fastening device 14 achieves stretching of at least one side of the fitting device 1, so that the corner elements 3, 30, 300 may be placed against two side edges 13 of the opening 2 by a movement of the adjusting devices 5, 50, 500 urged by operating the fastening device 14. The adjusting devices 5, 50, 500 are arranged radially around the fastening device 14, and at least two adjusting devices 5, 50, 500 arranged opposite of each other on one of the adjusting axis 8, 80, 800 are operable by the one fastening device 14.

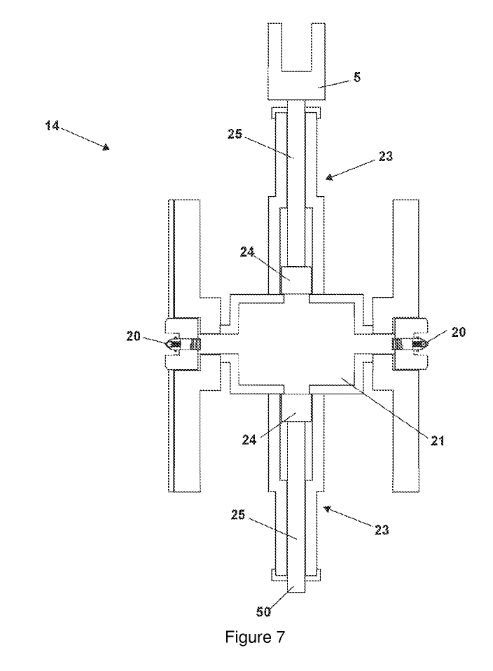

FIG. 7 shows a cross-sectional representation of an embodiment of a fastening device 14 for use in an inventive fitting device, which is operable by compressed air. Compressed air is introduced from a compressed-air cartridge (not shown) via a valve 20 into a compressed-air chamber. Valves 20 are arranged on both sides of the fastening device 14 so that the fastening device 14 may be operated from both sides. A cartridge guiding element is arranged in the area around the valve 20 in order to facilitate the application of compressed-air cartridges. In addition, the fastening device 14 comprises two pressure cylinders 23 including a pressure piston 24 and a piston rod 25. By the pressure cylinders 23, the adjusting devices 5, 50 connected with the piston rod 25 is moved away from the compressed-air chamber 21. The adjusting devices 5, 50 are arranged at opposite sides of the compressed-air chamber 21.

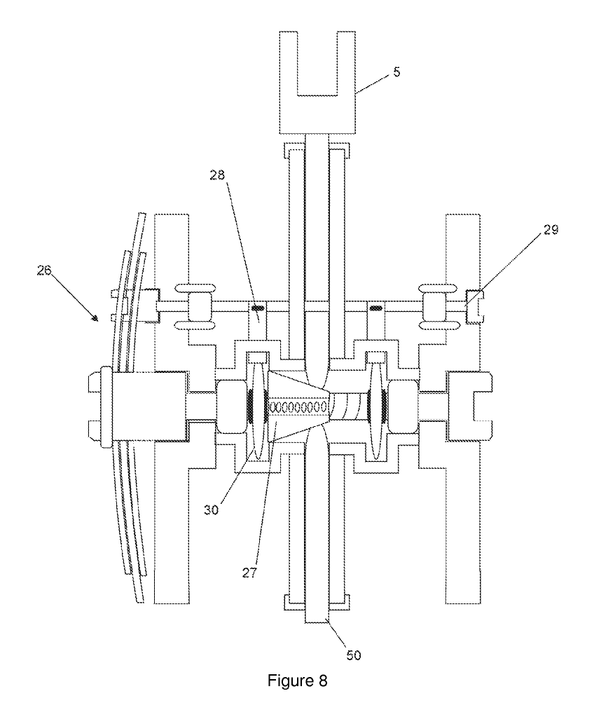

FIG. 8 shows a cross-sectional representation of a fastening device 14 by which a movement of the adjusting devices 5, 50 may be achieved. By a tensioning-spindle adjusting device 26, a tensioning spindle is moved in a direction essentially orthogonal to the movement to be achieved of the adjusting devices 5, 50. The tensioning-spindle adjusting device 26 is to be rotated so that the rotating movement of the tensioning-spindle adjusting device 26 causes a linear movement of the tensioning spindle via a thread. The tensioning thread 27 is rotated, which causes a linear movement of the adjusting devices 5, 50 due to the conical shape of the tensioning thread 27. A safety leaf 28 serves for securing the applied movement of the tensioning thread 27. The safety leaf 28 is coupled to the tensioning-spindle adjusting device 26 via a toothed wheel 30. By a safety device 29, the safety leaf 28 can be released, so that the applied movement of the adjusting devices 5, 50 can be released.

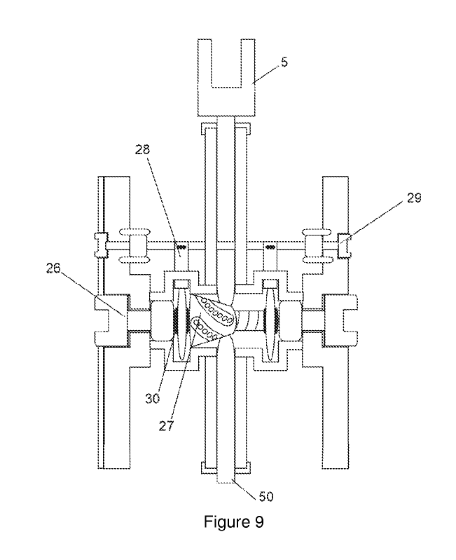

FIG. 9 shows a cross-sectional representation of a further embodiment of a fastening device 24, wherein, other than in the embodiment shown in FIG. 8, the tensioning spindle 28 is subject to a rotational and linear movement, wherein the adjusting devices 5, 50 are moved in a direction essentially orthogonal to the linear movement of the tensioning spindle 27.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

1.-12. (canceled)

13. A fitting device (1) for clamping in an opening (2), the fitting device (1) comprising at least one corner element (3, 30, 300, 3000), one side element (4, 40, 400, 4000), at least one adjusting device (5, 50, 500, 5000), and one fastening device (14) connected to the side element (4, 40, 400, 4000) via the adjusting device (5, 50, 500, 5000) for positioning the side element (4, 40, 400, 4000) against a side edge of the opening (2),
wherein the at least one corner element (3, 30, 300, 3000) is provided as a rigid element in an extension plane of the fitting device (1),
wherein the fastening device (14) is connected to the corner element (3, 30, 300, 3000) via the adjusting device (5, 50, 500, 5000) for positioning the corner element (3, 30, 300, 3000) against a side edge of the opening (2), and
wherein the adjusting elements (5, 50, 500, 5000) connected to the corner element (3, 30, 300, 3000) or the side element (4, 40, 400, 4000) are arranged radially around the one fastening device (14).

14. A fitting device (1) for clamping in an opening (2), the fitting device (1) comprising at least three side elements (4, 40, 400, 4000), adjusting devices (5, 50, 500, 5000), and one fastening device (14) connected to the side element (4, 40, 400, 4000) via adjusting devices (5, 50, 500, 5000) for positioning the side elements (4, 40, 400, 4000) against a side edge of the opening (2),
wherein the adjusting devices (5, 50) connected to the side elements (4, 40, 400, 4000) are arranged radially around the one fastening device (14).

15. A fitting device (1) for clamping in an opening (2), the fitting device (1) comprising at least three corner elements (3, 30, 300, 3000), adjusting devices (5, 50, 500, 5000), and one fastening device (14) connected to the corner elements (3, 30, 300, 3000) via the adjusting devices (5, 50, 500, 5000),
wherein the at least three corner elements (3, 30, 300, 3000) are provided as rigid elements in an extension plane of the fitting device (1),
wherein the one fastening device (14) is connected to at least one corner element (3, 30, 300, 3000) via one of the adjusting devices (5, 50, 500, 5000) for positioning the corner elements (3, 30, 300, 3000) against a side edge of the opening (2), and
wherein the adjusting devices (5, 50) are arranged radially around the one fastening device (14).

16. The fitting device according to claim 13, wherein the adjusting device (5, 50) comprises first adjusting elements (6, 6′, 60, 60′) and a second adjusting element (7, 70), wherein the second adjusting element (7, 70) is coupled to the fastening device (14) and the first adjusting elements (6, 6′, 60, 60′), and at least one of the first adjusting elements (6, 6′, 60, 60′) is coupled to the second adjusting element (7, 70) and the corner element (3, 30, 300, 3000) or the side element (4, 40, 400, 4000), and wherein at least the second adjusting element (7, 70) is arranged on an adjusting axis (8) and the first adjusting elements (6, 6′, 60, 60′) are arranged at any angle to the adjusting axis (8).

17. The fitting device (1) according to claim 13, wherein subsections of the corner element (3, 30, 300, 3000) are flexible.

18. The fitting device (1) according to claim 13, wherein the side element (4, 40, 400, 4000) is parallel to a longitudinal axis of the side element (4, 40, 400, 4000) and extractable from the corner element (3, 30, 300, 3000).

19. The fitting device (1) according to claim 13, wherein the side element (4, 40, 400, 4000) comprises a first side subelement and a second side subelement, and wherein the second side subelement is supported displaceably and parallel to a longitudinal axis of the first side element.

20. The fitting device (1) according to claim 13, wherein subsections of the side element (4, 40, 400, 4000) are flexible.

21. The fitting device (1) according to claim 13, wherein the fitting device (1) further comprises a surface element (15), the surface element (15) having a shape selected from a curved shape, a prism-shaped geometry, and a pyramid-shaped geometry.

22. The fitting device (1) according to claim 13, wherein the adjusting device (5, 50) is arranged at an angle to a plane defined by the corner elements (3, 30, 300, 3000) and/or the side elements (4, 40, 400, 4000).

23. The fitting device (1) according to claim 13, wherein the adjusting elements (6, 6′, 60, 60′, 7, 7′, 70, 70′) are adjustable in their length by a setting device.

24. The fitting device (1) according to claim 13, wherein the fitting device (1) is supported displaceably or pivotably.
